(19) United States
(12) Patent Application Publication
(10) Pub. No.: US 2024/0239643 A1
(43) Pub. Date: Jul. 18, 2024

(54) PRESSURE VESSEL FOR GAS AND BEVERAGE DISPENSER WITH PRESSURE VESSEL

(71) Applicant: Andreas JAHN, Tambach-Dietharz (DE)

(72) Inventor: Andreas JAHN, Tambach-Dietharz (DE)

(21) Appl. No.: 18/412,955

(22) Filed: Jan. 15, 2024

(30) Foreign Application Priority Data
Jan. 16, 2023 (DE) 10 2023 100 844.7

(51) Int. Cl. B67D 1/00; A47J 31/40; B67D 1/12

(52) U.S. Cl. CPC B67D 1/0058; A47J 31/407; B67D 1/0021; B67D 1/0072; B67D 1/1204; B67D 2001/0092; B67D 2210/00123

(57) ABSTRACT

The invention relates to a beverage bubbler (1) and a pressure vessel (2) for a gas for use in a beverage bubbler (1). According to the invention, the pressure vessel (2) or/and the beverage bubbler (1) has a flavor storage unit (4) which is designed to hold a flavor and to introduce the flavor into a gas which is intended for introduction into a beverage to be bubbled, or into the beverage.

### CROSS-REFERENCE TO RELATED APPLICATION

This application claims priority to German application no. DE 10 2023 100 844.7 filed on Jan. 16, 2023, which is hereby incorporated by reference in its entirety.

### BACKGROUND

### 1. Field of Invention

The invention relates to a pressure vessel for gas and a beverage dispenser.

### 2. Background Art

Beverage bubblers, also known as water bubblers or drinking water bubblers, are generally known from the state of the art. In one variant, they have a base unit into which a gas cartridge filled with carbon dioxide and a bottle filled with water are inserted. By actuating an operating unit on the base unit, the carbon dioxide is introduced into the bottle filled with water, causing the water to bubble. In a further variant, the gas cartridge filled with carbon dioxide is connected to a drinking water pipe. By activating a tap of the drinking water pipe in a corresponding position, the carbon dioxide is introduced into the drinking water pipe and thus into the water flowing through the drinking water pipe, causing it to bubble, so that the bubbled water flows out of the tap.

### SUMMARY

The invention is based on the task of providing an improved beverage dispenser compared to the prior art.

According to the invention, the task is solved by a beverage bubbler with the features of claim 1 and a pressure vessel with the features of claim 10.

Advantageous embodiments of the invention are the subject of the subclaims.

A beverage bubbler, also known as a water bubbler or drinking water bubbler, is provided in particular for bubbling, in particular carbonating, a beverage, in particular water, by introducing a gas, in particular carbon dioxide. The beverage bubbler can be designed for the discontinuous bubbling of a finite quantity of beverage or for the continuous bubbling of an indefinite quantity of beverage.

A beverage dispenser for discontinuously bubbling of a finite quantity of beverage is typically designed as a transportable device and can, for example, comprise a basic unit which has the following: a pressure vessel receptacle for holding a pressure vessel, a beverage container holder for holding a beverage container and an actuating unit for opening a fluidic connection between the pressure vessel arranged in the pressure vessel receptacle and the beverage container arranged in the beverage container holder when both containers are arranged in the respective holder. The pressure vessel is also referred to as a pressurized gas container, gas cartridge, cylinder or gas cylinder. The beverage container is in particular a cylinder. If a pressure vessel filled with gas, in particular carbon dioxide, and a beverage container filled with a beverage, in particular water, in particular drinking water, are arranged in the respective receptacle of the base unit, the beverage can be bubbled in the beverage container by actuating the actuating unit on the base unit, which opens the fluidic connection between the pressure vessel arranged in the pressure vessel receptacle and the beverage container arranged in the beverage container receptacle, as the gas then flows from the pressure vessel into the beverage container, for example through a gas supply line.

A beverage bubbler for continuously bubbling an indefinite quantity of beverage is typically permanently installed and connected, for example, to a domestic water installation or a dispensing system for bubbling, for example, drinking water or beers, soft drinks and the like on the way to a tap or dispensing tap (hereinafter uniformly referred to as a tap) and may comprise, for example, a base unit having: a pressure vessel receptacle for receiving a pressure vessel, a carbonator arranged in the beverage guide line for introducing gas into the beverage to be bubbled and an actuating unit for opening a fluidic connection between the pressure vessel arranged in the pressure vessel receptacle and the beverage supplied to the carbonator through the beverage guide line. Optionally, a storage container arranged in the beverage guide line can also be provided for the intermediate storage of already bubbled beverage until bubbled beverage is requested by actuating the tap. By actuating the actuating unit on the basic unit, which opens the fluidic connection between the pressure vessel arranged in the pressure vessel receptacle and the carbonator arranged in the beverage guide line, the beverage can be bubbled in the beverage guide line, as the gas then flows from the pressure vessel into the carbonator, for example through a gas guide line. The actuating unit can be realized, for example, by a pressure regulator that establishes the fluidic connection between the pressure vessel and the carbonator in the event of a defined pressure drop, such as occurs when the tap is opened, and interrupts this fluidic connection when the pressure in the gas supply line reaches a defined pressure because the tap has been closed. In this respect, the tap can be regarded as a component of the beverage dispenser.

According to the invention, the beverage bubbler has a flavor storage unit which is designed to hold a flavor and to introduce the flavor into the gas which is intended to be introduced into the beverage to be bubbled, or to introduce the flavor into the beverage. In certain embodiments of the invention, the flavor storage unit is part of the pressure vessel.

The beverage dispenser or the pressure vessel can also have several such flavor storage units. The following description, in particular with regard to the design, arrangement and operation of the flavor storage unit, then applies to the respective flavor storage unit. The multiple flavor storage units can be the same or different in terms of their design, arrangement and mode of operation. The multiple flavor storage units are particularly advantageous for providing different flavors. It is therefore particularly intended that a different flavor is stored or can be stored in each of the flavor storage units. One of the flavors can then be selected to flavor a respective beverage. It is therefore particularly intended that the flavor storage units can be switched on as required to flavor the beverage. In particular, the beverage dispenser therefore has a flavor selection function for selecting the flavor and thus the flavor storage unit providing the selected flavor. In particular, it therefore has a switch-on function for switching on the respective selected flavor storage unit for flavoring the respective beverage.

As mentioned above, the gas is carbon dioxide in particular. Introducing the gas into the beverage makes the beverage fizzy.

By introducing the flavor from the flavor storage unit into the gas and with it into the beverage or by introducing the flavor from the flavor storage unit directly into the beverage, the beverage is flavored, i.e. in particular it is given a taste corresponding to the flavor.

To introduce the flavor into the gas or directly into the beverage, the flavor storage unit is designed in particular in such a way that the gas flows directly through the flavor storage unit before being introduced into the beverage or the beverage itself and is flavored in the process, i.e. the stored flavor or a portion of the stored flavor is carried along. To introduce the flavor into the gas, the flavor storage unit can alternatively be designed in such a way that the gas flows laterally past the flavor storage unit and sucks in the flavor or a portion of the flavor from the flavor storage unit, in particular through the Venturi effect, and is flavored in this way, i.e. takes the flavor or the portion of the flavor sucked in with it.

Alternatively, the flavor storage unit can, for example, be designed in such a way that it opens to introduce the flavor into the gas or directly into the beverage and releases the flavor or a portion of the flavor. In particular, the flavor storage unit is designed as a container or has a container in which the flavor is stored. The flavor or the proportion of the flavor then drips or flows into the gas before it is introduced into the beverage or directly into the beverage, for example. The flow into the gas can also take place, for example, by the flavoring or the portion of the flavoring being sucked in by the gas flowing past, in particular by means of the Venturi effect, as described above.

For example, filling the flavor storage unit with the flavor or with a component containing the flavor is provided in order to store the flavor in the flavor storage unit. With the flavor storage unit according to the invention, it is no longer necessary to fill the flavor directly into a pressurized container for storing the gas, and it is likewise no longer necessary to manually fill the flavor into the beverage before or after the beverage is bubbled. In particular, the flavor storage unit according to the invention enables automatic flavoring of the beverage, whereby this takes place in particular during the effervescence.

The flavor storage unit is designed, for example, as a cartridge, a pad or a fleece or as a porous unit or has, for example, a cartridge, a pad or a fleece or a porous unit as a component that contains the flavor. The pad and the fleece are intended in particular to be flowed through by the gas or the beverage in order to introduce the flavoring into the gas or the beverage. The porous unit can be designed to be flowed through or flowed against by the gas or beverage in order to introduce the flavoring into the gas or beverage. The cartridge is in particular a container for the flavoring in the form of a hollow body, in particular a tank, from which it can, for example, be sucked out or flow out or drip out.

It may advantageously be provided that the flavor storage unit is replaceable or that the component of the flavor storage unit that contains the flavor, for example the cartridge or the pad or the fleece or the porous unit, is replaceable. This makes it easy to refill the flavoring. Furthermore, different flavors can be used without having to replace the pressurized container. In contrast to this, when the flavoring is filled into the pressure vessel as described above in the prior art, it is necessary to replace the pressure vessel if a different flavoring is desired for the beverage.

In one possible embodiment, the flavor storage unit is arranged, for example, in or on a gas guide line for guiding the gas from the pressure vessel into the beverage to be sparkling. The flavor storage unit is arranged, for example, between the pressure vessel and the beverage container or in an outlet area, in particular at a bubble nozzle, of the gas supply line in or on the gas supply line. In this embodiment, the flavor can thus be introduced into the gas flowing through the flavor storage unit or flowing past the flavor storage unit before this gas flows into the beverage to be sparkling. The beverage is thus bubbled with flavored gas, whereby the beverage is flavored.

The arrangement described is also possible independently of the beverage dispenser, i.e., for example, only the gas guide line is provided with the flavor storage unit and can be coupled to a beverage dispenser, for example. The flavor storage unit is then arranged, for example, between a connection for the pressure vessel and the beverage container or in an outlet area, in particular at an effervescent nozzle, of the gas guide line in or on the gas guide line.

In particular, it is intended that the gas supply line and the flavor storage unit are fluidically connected to each other or can be switchably connected to each other. The fluidic connection can be switched manually or automatically, for example. The switchable connection makes it possible, in particular, for the beverage to be bubbled using the gas without adding flavor to the beverage at the same time.

If the flavor storage unit, as described above, is arranged in an outlet area, in particular at the bubble nozzle, of the gas guide line in or on the gas guide line, then it can project into the beverage container during bubbling or be positioned therein. In this embodiment, the flavor is nevertheless advantageously only introduced into the gas flowing through the gas guide line and then enters the beverage together with the gas.

For example, the gas guide line in the area of the flavor storage unit has a suction opening for sucking the flavor out of the flavor storage unit due to a flow of gas through the gas guide line. The flavor is drawn in in particular by using the Venturi effect. In particular, it is intended that the flavor is drawn in due to the gas flowing past the suction opening.

In a further possible embodiment, the flavor storage unit is arranged, for example, in or on the beverage container or a beverage conduit for the beverage. In this embodiment, it is particularly intended that the flavor can be introduced directly into the beverage, for example before the bubbling, during the bubbling and/or after the bubbling of the beverage. The arrangement described is also possible independently of the beverage dispenser, i.e., for example, only the beverage container is provided with the flavor storage unit and can be coupled to a beverage dispenser, for example, or, for example, only the beverage guide line is provided with the flavor storage unit and can be coupled to a beverage dispenser.

The beverage supply line is a drinking water line, for example. In particular, the pressure vessel is also connected to this drinking water line. For example, by actuating a tap of the drinking water line in a corresponding position, the gas and also the flavor can then be introduced into the drinking water line and thus into the water flowing through the drinking water line, thus bubbling and flavoring it so that the bubbled and flavored water flows out of the tap. For example, a further position of the tap can be provided in which only the gas is introduced into the drinking water line and thus into the water flowing through the drinking water line, so that the water is only bubbled and the bubbled water flows out of the tap, and/or, for example, a further position of the tap can be provided in which only the flavor is introduced into the drinking water line and thus into the water flowing through the drinking water line, so that the water is only flavored and the flavored and non-bubbled water flows out of the tap, and/or, for example, a further position of the tap can be provided in which neither flavor nor gas is introduced into the drinking water line and thus into the water flowing through the drinking water line, so that the water is neither flavored nor bubbled and thus normal drinking water flows out of the tap. In a similar way, the pressure vessel can be coupled to a dispensing line of a dispensing device or the like and the beverage fed through it can be carbonated and flavored in this way when the associated tap is opened.

In particular, it is intended that the beverage container or the beverage guide line and the flavor storage unit are fluidically connected to each other or can be switchably connected to each other. In the case of the beverage guide line, for example, this can be done in the manner described above by actuating the tap in the corresponding position. The fluidic connection can be switched manually or automatically, for example. The switchable connection makes it possible, in particular, for the beverage to be bubbled using the gas without adding flavor to the beverage at the same time.

In a further possible embodiment, the flavor storage unit is arranged, for example, in or on the pressure vessel in which the gas is stored. In this embodiment, it is thus provided in particular that the flavor can be introduced into the gas in the pressure vessel, in particular into the gas flowing out of the pressure vessel before it leaves the pressure vessel, in particular in a valve of the pressure vessel or in the region of the valve. In particular, the flavor can be introduced into the gas flowing through the valve. As a result, not all of the gas in the pressure vessel is flavored at the same time, but only the respective gas flowing out of the pressure vessel, in particular immediately before it flows out. Alternatively, however, it may also be provided that the flavor can be introduced directly into the pressure vessel and thus in particular directly into the gas contained therein, whereby in particular the entire gas in the pressure vessel is flavored.

The arrangement described is also possible independently of the beverage dispenser, i.e., for example, only the pressure vessel is provided with the flavor storage unit and can be coupled to a beverage dispenser, for example.

In particular, it is intended that the pressure vessel and the flavor storage unit are fluidically connected to each other or can be connected to each other in a switchable manner. This is particularly advantageous in the variant described, in which the flavor can be introduced into the gas flowing through the valve. Switching can take place, for example, by actuating the valve, i.e. when the valve is moved into an outflow position, the fluidic connection is also established. For example, it may also be possible to move the valve into the outflow position or into a further outflow position without establishing the fluidic connection, for example by actuating the valve in a different way. This makes it possible for unflavored gas to flow out so that the beverage is only bubbled by means of the gas and is not additionally flavored.

In one possible embodiment, the flavor storage unit is arranged, for example, on the valve of the pressure vessel. The flavor storage unit can, for example, be arranged in the pressure vessel, i.e. in an interior of the pressure vessel, on the valve in the manner described above or arranged on the valve outside the pressure vessel. In particular when arranged in the pressure vessel, the flavor storage unit is arranged in particular in a lower region or on an underside of the valve. In this embodiment, it is thus provided in particular that the flavor can be introduced into the gas flowing out of the pressure vessel, in particular in the region of the valve, in particular while the gas is flowing through the valve or immediately thereafter, thus for example before the gas leaves the pressure vessel and/or immediately after the gas has left the pressure vessel. In particular, the flavor can be introduced into the gas flowing through the valve, for example by the gas flowing through or past the flavor storage unit before flowing through the valve and/or while flowing through the valve and/or after flowing through the valve and, in particular, by the flavor being sucked in or by the flavor being released, for example drop by drop, in particular when the valve is actuated, i.e. when the valve is moved to the outflow position, and these flavor drops being absorbed by the gas flowing through the valve.

The arrangement described is also possible independently of the beverage dispenser, i.e., for example, only the valve with the flavor storage unit is provided for the pressure vessel and can be coupled, for example, to a beverage dispenser and/or to a pressure vessel, or the pressure vessel, comprising the valve with the flavor storage unit, is provided and can be coupled to a beverage dispenser.

In particular, it is intended that the valve and the flavor storage unit are fluidically connected to each other or can be connected to each other in a switchable manner. Switching can take place, for example, as already described above, by actuating the valve, i.e. when the valve is moved into the outflow position, the fluidic connection is also established. It can therefore be provided in particular that the flavor storage unit is closed by the valve in a closed valve position and is fluidically connected to the valve, in particular to a gas outflow channel of the valve, in the outflow position of the valve.

For example, as mentioned above, the valve can also be moved to the outflow position or another outflow position without establishing the fluidic connection, for example by actuating the valve in a different way. This makes it possible for unflavored gas to flow out, so that the beverage is only bubbled by means of the gas and is not additionally flavored.

In one possible embodiment, the valve has an flavor filling opening for filling the flavor storage unit with flavor through the valve. As a result, it is not necessary to remove the valve from the pressure vessel to fill the flavor storage unit; instead, the flavor storage unit can be filled with flavor through the valve and thus in a similar way to filling the pressure vessel with gas.

In order to prevent gas from escaping from the pressure vessel during filling of the flavor storage unit via the flavor filling opening, it is provided in particular that the flavor filling opening, in particular in an open position, is not fluidically connected to the interior of the pressure vessel, i.e. is fluidically separated from it. For this purpose, it is provided in particular that the valve is designed accordingly. For example, it may be provided that the flavor filling opening can be opened and closed by corresponding actuation of the valve or a component of the valve. To open the flavor filling opening, the valve is in particular in the closed valve position and in particular remains in this closed valve position while the flavor filling opening is open.

For example, the valve can be designed in such a way that the flavor filling opening can be opened and closed by means of a valve tappet, by means of which the valve can also be moved into the outflow position and into the closed valve position. In this case, the valve is designed in particular in such a way that the valve can be moved into the outflow position by moving the valve tappet into an outflow position and into the closed valve position by moving the valve tappet into a closed position that differs from the outflow position, and the valve tappet can also be moved into an flavor filling position that differs from the outflow position and the closed position, in which the flavor filling opening is open, the valve being located in particular in the closed valve position, i.e. the interior of the pressure vessel is in the closed valve position. i.e. the interior of the pressure vessel is closed by the valve.

Alternatively, a separate plunger or another closing element can be provided for opening and closing the flavor filling opening, for example.

The pressure vessel mentioned in this application is in particular a pressurized gas container and is designed to hold the gas under high pressure. In particular, the pressure vessel is a so-called gas cartridge, in particular for the beverage dispenser.

### BRIEF DESCRIPTION OF THE DRAWINGS

Examples of embodiments of the invention are explained in more detail below with reference to drawings.

Show therein:

FIG. 1 schematic of an embodiment of a beverage dispenser,

FIG. 2 schematic of a further embodiment of a beverage dispenser,

FIG. 3 schematic of a further embodiment of a beverage dispenser,

FIG. 4 schematic representation of a pressure vessel of a further embodiment of a beverage dispenser, wherein the pressure vessel has a valve, and wherein the valve is shown in a closed valve position,

FIG. 5 schematic of the pressure vessel of FIG. 4, with the valve shown in an outflow position, and

FIG. 6 schematic of the pressure vessel shown in FIG. 4, with the valve shown in the outflow position and the outflow of a gas and a flavor from the pressure vessel.

Corresponding parts are provided with the same reference signs in all figures.

### DETAILED DESCRIPTION OF SPECIFIC EMBODIMENTS

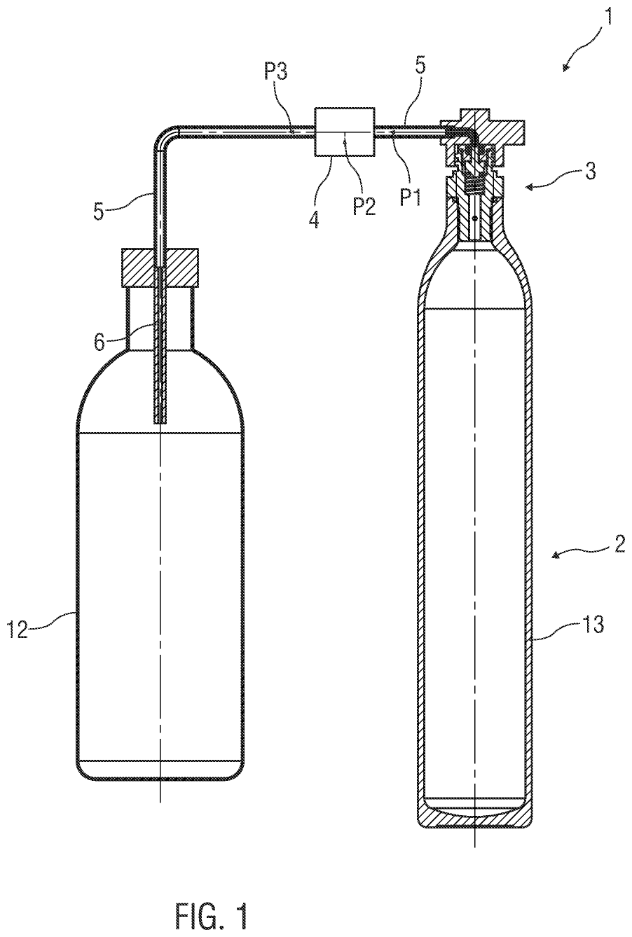

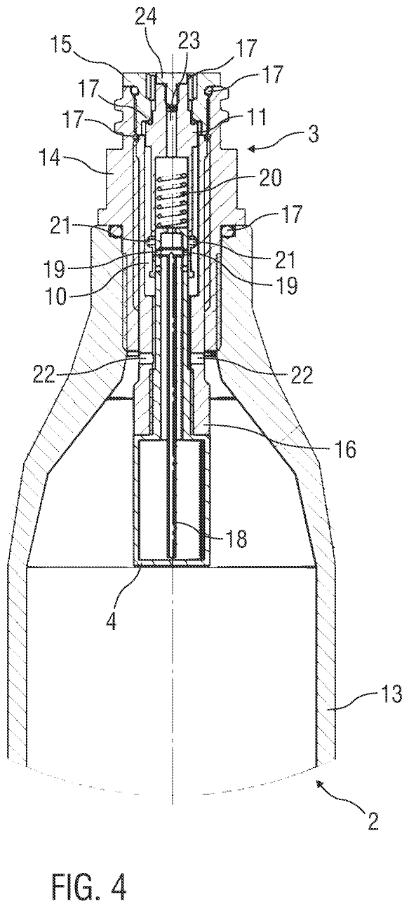

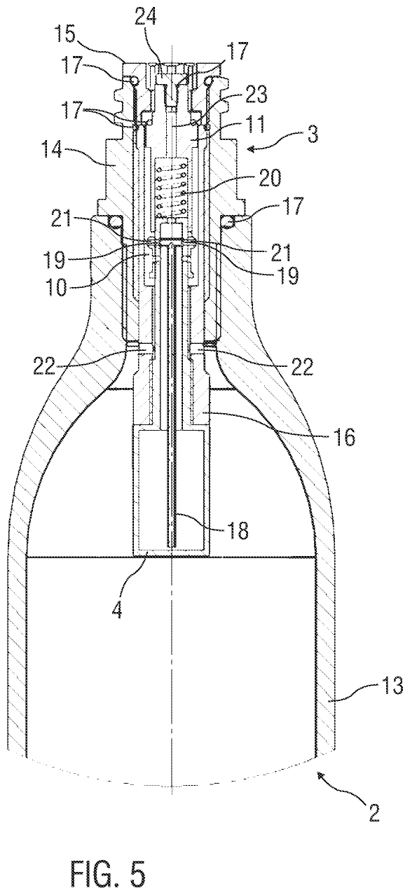

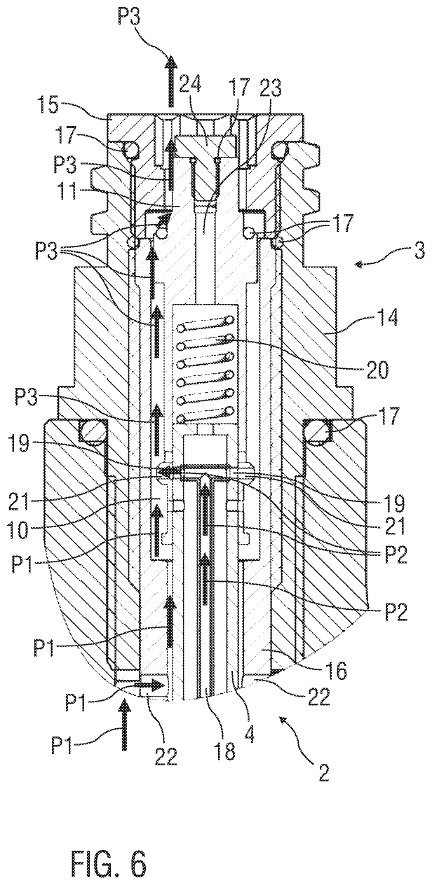

FIGS. 1 to 3 show examples of various possible embodiments of a beverage dispenser 1. FIGS. 4 to 6 show examples of a pressure vessel 2 of a further embodiment or for a further embodiment of the beverage dispenser 1, wherein FIG. 4 shows a closed valve position of a valve 3 of the pressure vessel 2 and FIGS. 5 and 6 show an outflow position of the valve 3. FIG. 6 schematically shows an outflow of a gas, in particular carbon dioxide, and an flavor from the pressure vessel 2, with first arrows P1 showing the flowing gas, second arrows P2 showing the flowing flavor and third arrows P3 showing the flowing flavored gas, i.e. the gas mixed with the flavor, i.e. a gas-flavor mixture.

The beverage dispenser 1 has an flavor storage unit 4, which is designed to hold a flavor and, in the examples shown, to introduce the flavor into the gas, which is intended for introduction into a beverage to be dispensed. In the examples shown in FIGS. 1 to 3, the beverage is located in a beverage container 12, for example in the form of a water bottle.

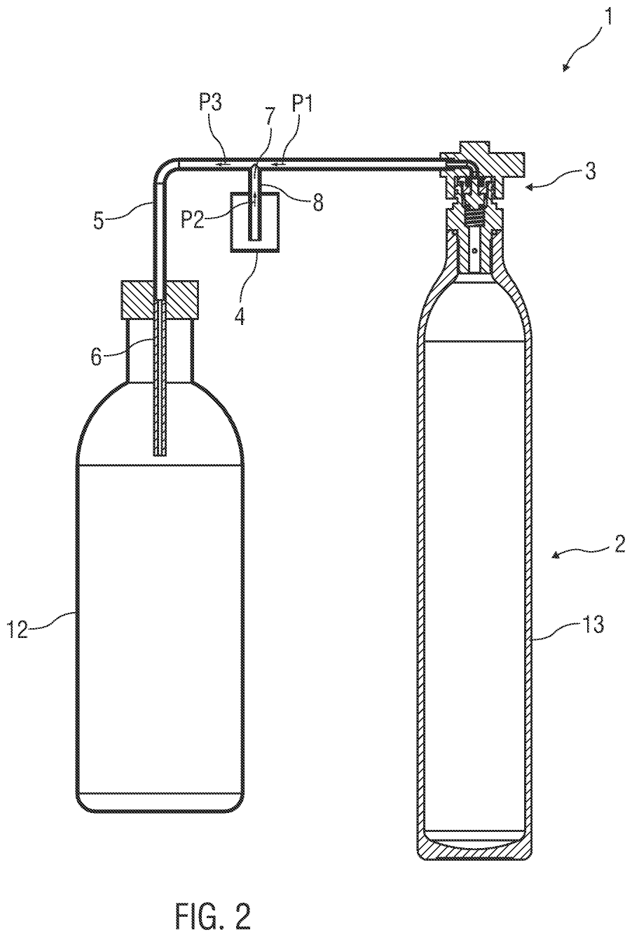

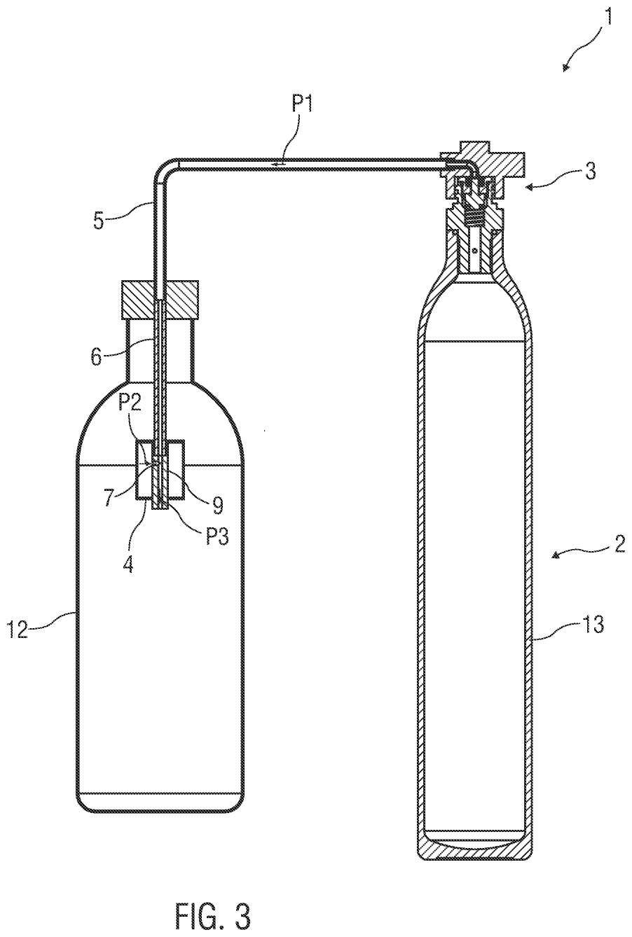

To introduce the flavor into the gas, the flavor storage unit 4 is designed, for example, in such a way that the gas flows through the flavor storage unit 4 before being introduced into the beverage and is flavored in the process, i.e. the stored flavor or a portion of the stored flavor, as shown by way of example in FIGS. 1 and 3, or, for example, such that the gas flows laterally past the flavor storage unit 4 and in the process draws in the flavor or a portion of the flavor from the flavor storage unit 4, in particular by means of the Venturi effect, and is flavored in this way, i.e. takes the drawn-in flavor or the drawn-in portion of the flavor with it, as shown by way of example in FIGS. 2 and 4 to 6. In the example shown in FIG. 3, for example, the Venturi effect can also be used, because although the gas flows through the flavor storage unit 4, it remains in a gas guide line 5, in particular in a bubble nozzle 6 of the gas guide line 5, which has a suction opening 7 in the area of the flavor storage unit 4 for sucking in the flavor from the flavor storage unit 4.

For example, filling the flavor storage unit 4 with the flavor or with a component containing the flavor is provided for receiving the flavor in the flavor storage unit 4.

The flavor storage unit 4 is designed, for example, as a pod, as a cartridge, as a pad or as a fleece or as a porous unit or has, for example, a cartridge, a pad or a fleece or a porous unit as a component containing the flavor. In particular, the pad and the fleece are intended to be flowed through by the gas in order to introduce the flavoring into the gas. The porous unit can be designed to be flowed through or flowed against by the gas in order to introduce the flavor into the gas. The cartridge is in particular a container for the flavoring in the form of a hollow body, in particular a tank, from which it can, for example, be sucked out or flow out or drip out.

It may advantageously be provided that the flavor storage unit 4 is replaceable or that the component of the flavor storage unit 4 that contains the flavor, for example the cartridge or the pad or the fleece or the porous unit, is replaceable.

In the embodiment shown in FIG. 1, the flavor storage unit 4 is arranged in the gas guide line 5 for guiding the gas from the pressure vessel 2 into the beverage to be sparkling. In the embodiments shown in FIGS. 2 and 3, the flavor storage unit 4 is arranged on the gas guide line 5 for guiding the gas from the pressure vessel 2 into the beverage to be bubbled. In FIG. 2, the flavor storage unit 4 is arranged on the gas supply line 5 by means of a connecting line 8. In FIG. 3, the flavor storage unit 4 is arranged on the bubble nozzle 6 of the gas supply line 5. In this case, an extension 9 of the gas supply line 5, in particular of its bubble nozzle 6, is formed in the flavor storage unit 4. The suction opening 7 is formed in this extension 9.

In particular, it is intended that the gas guide line 5 and the flavor storage unit 4 are fluidically connected to each other, as shown in FIGS. 1 to 3, or can be connected to each other in a switchable manner. The fluidic connection can be switched manually or automatically, for example. The switchable connection makes it possible, in particular, for the beverage to be bubbled using the gas without adding flavor to the beverage at the same time.

As already mentioned above, in some embodiments, shown by way of example in FIGS. 2 and 3, the gas conduit 5 has the suction opening 7 in the area of the flavor storage unit 4 for sucking in the flavor from the flavor storage unit 4 due to the flow of the gas through the gas conduit 5. The flavor is drawn in in particular by using the Venturi effect. In particular, it is intended that the flavor is drawn in due to the gas flowing past the suction opening 7. In the example shown in FIG. 2, the connecting line 8 and, via it, the flavor storage unit 4 is fluidically connected to this suction opening 7 of the gas supply line 5. In the example shown in FIG. 3, the suction opening 7 is formed in the extension 9 of the gas guide line 5, in particular the bubble nozzle 6.

In the embodiment shown in FIGS. 4 to 6, the flavor storage unit 4 is arranged on the valve 3 of the pressure vessel 2. Here, the flavor storage unit 4 is arranged in the pressure vessel 2, i.e. in an interior of the pressure vessel 2, at the valve 3, in particular in a lower region of the valve 3. In this embodiment, it is thus provided that the flavor can be introduced into the gas flowing out of the pressure vessel 2 in the region of the valve 3, in particular while the gas is flowing through the valve 3. In the example shown, this is achieved by the gas flowing past the flavor storage unit 4 while flowing through the valve 3 and sucking in the flavor.

In the embodiment shown, the valve 3 and the flavor storage unit 4 can be connected to each other in a switchable manner. Switching takes place by actuating the valve 3, i.e. when this is moved into the outflow position, the fluidic connection is also established, as can be seen in the comparison of FIG. 4, which shows the closed valve position, with FIGS. 5 and 6, which show the outflow position. In the example shown, it is therefore intended that the flavor storage unit 4 is closed by the valve 3 in the closed valve position and is fluidically connected to the valve 3, in particular to a gas outflow channel 10 of the valve 3, in the outflow position of the valve 3.

The structure and mode of operation of the exemplary embodiment shown in FIGS. 4 to 6 are described in more detail below. As in the examples shown in FIGS. 1 to 3, the pressure vessel 2 here is in particular a pressurized gas vessel and is designed to hold the gas under high pressure. In particular, the pressure vessel 2 is a so-called gas cartridge, in particular for the beverage dispenser 1.

The pressure vessel 2 has a container body 13 with a container base arranged at a lower end and, in particular, formed in one piece with the container body 13.

At an upper end and thus opposite the container base, the container body 13 has an end region, which is formed in particular in one piece with the container body 13. The end region has a container opening.

The container base, the container body 13 and the end region are formed in particular as a homogeneous, one-piece component without joints and are produced together in a forming process, for example a roll forming process, from a material blank, for example from an aluminum blank or another material.

The pressure vessel 2 also has the valve 3, which is designed in particular as a non-return valve. This valve 3 is arranged at least in sections within the end region. For this purpose, the pressure vessel 2 has a fastening structure for the valve 3 formed on the inside of the wall surrounding the container opening of the end section. In particular, the fastening structure has an internal thread arranged on the inside of the wall. The valve 3, in the example shown a valve body 14 of the valve 3, has an external thread corresponding to the internal thread of the fastening structure.

In the example shown, the valve 3 comprises the valve body 14, an upper part 15, an insert 16, the valve tappet 11 and the flavor storage unit 4. The valve body 14 is sealed in the container body 13 by means of a seal 17. The insert 16 is arranged in the valve body 14 and protrudes downwards beyond the valve body 14 into the interior of the pressure vessel 2. Here it has inlet openings 22 to the gas outlet channel 10. The flavor storage unit 4 is arranged at the bottom of the insert 16 and projects upwards into the insert 16. The flavor storage unit 4 has a riser pipe 18, which extends into a base area of the flavor storage unit 4 in order to draw in the flavor there, and is T-shaped at an upper end and opens into outflow openings 19 of the flavor storage unit 4.

The valve tappet 11 is supported by a compression spring 20 on the flavor storage unit 4 in the upper part 15 and the insert 16 in the axial direction of the valve 3 against the spring force of the compression spring 20 downwards into the outflow position and by means of the spring force of the compression spring 20 back upwards into the closed valve position and encloses the upper area of the flavor storage unit 4. The upper part 15 is screwed into the valve body 14 in a sealed manner with a seal 17. It is in sealed contact with the insert 16 via a seal 17.

In the closed valve position, a shaped part of the valve tappet 11 is in sealed contact with the upper part 15 via a seal 17. As a result, the interior of the pressure vessel 2 is closed by means of the valve 3. In the outflow position, the shaped part of the valve tappet 11 is lifted downwards from the upper part 15, opening the gas outflow channel 10 so that the gas can flow out of the pressure vessel 2 through it. The gas outflow channel 10 runs at the bottom between the insert 16 and the flavor storage unit 4, above it between the insert 16 and the valve tappet 11 and above it between the valve tappet 11 and the upper part 15.

The valve tappet 11 has flow openings 21 which, in the outflow position, are arranged at the outflow openings 19 of the flavor storage unit 4, so that the gas flowing past these flow openings 21 can suck the flavor out of the flavor storage unit 4 via the flow openings 21 and the outflow openings 19, as shown in FIG. 6. By moving the valve tappet 11 by means of the compression spring 20 into the closed valve position and thus also relative to the flavor storage unit 4, the flow openings 21 in the valve tappet 11 are also moved upwards, so that the outflow openings 19 of the flavor storage unit 4 are closed by a wall of the valve tappet 11, as shown in FIG. 4.

In the example shown, the valve 3 has a flavor filling opening 23 for filling the flavor storage unit 4 with flavor through the valve 3. In the example shown, this flavor filling opening 23 extends through the valve tappet 11 to the flavor storage unit 4, which has an opening at its upper end as the lower end of the flavor filling opening 23. An upper end of the flavor filling opening 23 is closed by means of a cover 24 in the valve tappet 11. To fill the flavor storage unit 4, the lid 24 is removed and the flavor is poured in, which then runs down through the flavor filling opening 23 into the flavor storage unit 4. The lid 24 closes the flavor filling opening 23 in a sealed manner by means of a seal 17, so that the gas cannot flow out via the flavor filling opening 23 when the valve 3 is in the outflow position. The flavor storage unit 4 is only filled in the closed valve position, so that no gas can escape here either.

### LIST OF REFERENCE SIGNS

1 beverage dispenser
2 pressure vessel
3 valve
4 flavor storage unit
5 gas supply line
6 sparkling nozzle
7 suction opening
8 connecting line
9 extension
10 gas outlet channel
11 valve tappet
12 beverage vessel
13 container body
14 valve body
15 upper part
16 insert
17 seal
18 riser
19 outflow opening
20 compression spring
21 flow through opening
22 admission opening
23 flavor filling opening
24 cover
P1 first arrow
P2 second arrow
P3 third arrow

1. A beverage dispenser (1), at least comprising:
a pressure vessel (2) for holding gas which is intended for introduction into a beverage to be bubbled,
a beverage container (12) or/and a beverage guide line for the beverage, and
an actuating unit for opening a fluidic connection between the pressure vessel (2) and the beverage container (12) or/and the beverage guide line,
characterized by a flavor storage unit (4) which is designed to hold a flavor and to introduce the flavor into the gas or into the beverage.

2. The beverage dispenser (1) according to claim 1,
characterized in that the flavor storage unit (4)
is arranged in or on a gas guide line (5) for guiding the gas from a pressure vessel (2) into the beverage to be bubbled, the gas guide line (5) and the flavor storage unit (4) being fluidically connected to one another or being connectable to one another in a switchable manner, or
is arranged in or on a beverage container (12) or a beverage guide line for the beverage, wherein the beverage container (12) or the beverage guide line and the flavor storage unit (4) are fluidically connected to one another or can be switchably connected to one another, or
is arranged in or on the pressure vessel (2) in which the gas is stored, wherein the pressure vessel (2) and the flavor storage unit (4) are fluidically connected to one another or can be switchably connected to one another.

3. The beverage dispenser (1) according to claim 2,
characterized in that the flavor storage unit (4) is arranged between the pressure vessel (2) and the beverage container (12) or in an outlet region of the gas conduit (5) in or on the gas conduit (5).

4. The beverage dispenser (1) according to claim 2,
characterized in that the gas guide line (5) has a suction opening (7) in the region of the flavor storage unit (4) for sucking in the flavor from the flavor storage unit (4) due to a flow of the gas through the gas guide line (5).

5. The beverage dispenser (1) according to claim 1,
characterized in that the flavor storage unit (4) is designed as a pod, as a cartridge, as a pad or as a fleece or as a porous unit or comprises a pod, a cartridge, a pad or a fleece or a porous unit.

6. The beverage dispenser (1) according to claim 5,
characterized in that the flavor storage unit (4) or the pod or cartridge or the pad or the fleece or the porous unit of the flavor storage unit (4) is replaceable.

7. The beverage dispenser (1) according to claim 1,
characterized in that the flavor storage unit (4) is arranged on a valve (3) of the pressure vessel (2).

8. The beverage dispenser (1) according to claim 7,
characterized in that the flavor storage unit (4) is closed by the valve (3) in a closed valve position and is fluidically connected to a gas outflow channel (10) of the valve (3) in an outflow position of the valve (3).

9. The beverage dispenser (1) according to claim 7,
characterized in that the valve (3) has a flavor filling opening (23) for filling the flavor storage unit (4) with flavor through the valve (3).

10. A pressure vessel (2) for holding a gas, comprising a container body (13) with a container base and an end region opposite the container base with a container opening and a valve (3) arranged at least in sections within the end region, characterized in that
a flavor storage unit (4) is arranged in the pressure vessel (2), which is designed to hold a flavor and to introduce the flavor into the gas which is intended for introduction into a beverage to be sparkling.

11. The pressure vessel (2) according to claim 10,
characterized in that the flavor storage unit (4) is designed as a pod, as a cartridge, as a pad or as a fleece or as a porous unit or has a pod, a cartridge, a pad or a fleece or a porous unit.

12. The pressure vessel (2) according to claim 11,
characterized in that the flavor storage unit (4) or the pod or cartridge or the pad or the fleece or the porous unit of the flavor storage unit (4) is replaceable.

13. The pressure vessel (2) according to claim 10,
characterized in that the flavor storage unit (4) is arranged on a valve (3) of the pressure vessel (2).

14. The pressure vessel (2) according to claim 13,
characterized in that the flavor storage unit (4) is closed by the valve (3) in a closed valve position and is fluidically connected to a gas outflow channel (10) of the valve (3) in an outflow position of the valve (3).

15. The pressure vessel (2) according to claim 13,
characterized in that the valve (3) has a flavor filling opening (23) for filling the flavor storage unit (4) with flavor through the valve (3).
